(19) United States
(12) Patent Application Publication
(10) Pub. No.: US 2021/0256732 A1
(43) Pub. Date: Aug. 19, 2021

(54) IMAGE PROCESSING METHOD AND UNMANNED AERIAL VEHICLE

(71) Applicant: SZ DJI TECHNOLOGY CO., LTD., Shenzhen (CN)

(72) Inventors: Changchun YE, Shenzhen (CN); You ZHOU, Shenzhen (CN); Zhenfei YANG, Shenzhen (CN)

(21) Appl. No.: 17/231,974

(22) Filed: Apr. 15, 2021

Related U.S. Application Data
(63) Continuation of application No. PCT/CN2018/118787, filed on Nov. 30, 2018.

(51) Int. Cl. G06T 7/73; G05D 1/08; G05D 1/10; B64C 39/02; G06T 7/593

(52) U.S. Cl. CPC G06T 7/74; G05D 1/0808; G05D 1/101; B64C 39/024; G06T 2207/30244; B64C 2201/027; B64C 2201/127; G06T 2207/10032; G06T 7/593

(57) ABSTRACT

Embodiments of the present disclosure provide an image processing method applied in an unmanned aerial vehicle (UAV), the UAV including an imaging device in two or more directions. The method includes obtaining an image to be processed in each of the two or more directions; determining a first direction in the two or more directions and obtaining a first direction reference value based on the image to be processed in each of the two or more directions, the first direction reference value being used to determine whether to update key reference frames corresponding to the two or more directions respectively; and updating the key reference frames corresponding to the two or more directions respectively if the first direction reference value meets a preset condition.

### CROSS-REFERENCE TO RELATED APPLICATIONS

This application is a continuation of International Application No. PCT/CN2018/118787, filed on Nov. 30, 2018, the entire content of which is incorporated herein by reference.

### TECHNICAL FIELD

The present disclosure relates to the technical field of movable platforms and, more specifically, to an image processing method and an unmanned aerial vehicle (UAV).

### BACKGROUND

Computer vision technology refers a simulation of biological vision using computers and various imaging devices. By processing images or videos collected by the imaging devices, three-dimensional (3D) information of the corresponding scene can be obtained.

UAV is an important application field of computer vision technology. The UAV can extracts feature points from the image collected by the imaging device, perform feature point matching of a plurality of frames of images to calculate the attitude of the imaging device, and measure its own moving distance and the 3D position of the point in the image. A plurality of imaging devices can be disposed in multiple directions of the UAV, for example, vision sensors can be disposed at the front and the back of the UAV. In each direction, the key reference frames can be selected based on the respective attitudes of the vision sensor, and the respective calculation results can be calculated based on the respective key reference frames, then the calculation results in multiple directions can be combined and used.

However, since each direction selects the key reference frame and updates the key reference frame separately, the amount of calculation is relatively large and a large amount of calculation resources are consumed, which reduces the processing efficiency of the UAV.

### SUMMARY

One aspect of the present disclosure provides an image processing method applied in an unmanned aerial vehicle (UAV), the UAV including an imaging device in two or more directions. The method includes obtaining an image to be processed in each of the two or more directions; determining a first direction in the two or more directions and obtaining a first direction reference value based on the image to be processed in each of the two or more directions, the first direction reference value being used to determine whether to update key reference frames corresponding to the two or more directions respectively; and updating the key reference frames corresponding to the two or more directions respectively if the first direction reference value meets a preset condition.

Another aspect of the present disclosure provides a UAV, including a processor; and a storage device storing program instructions. When being executed by the processor, the program instructions cause the processor to: obtain an image to be processed in each direction of two or more directions; determine a first direction in the two or more directions and obtain a first direction reference value based on the image to be processed in each of the two or more directions, the first direction reference value being used to determine whether to update key reference frames corresponding to the two or more directions respectively; and update the key reference frames corresponding to the two or more directions respectively if the first direction reference value meets a preset condition.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic architecture diagram of a UAV according to an embodiment of the present disclosure.

FIG. 2 is a flowchart of an image processing method according to an embodiment of the present disclosure.

FIG. 3 is a flowchart of the image processing method according to another embodiment of the present disclosure.

FIG. 4 is a schematic diagram of the principle of a triangulation algorithm involved in an embodiment of the present disclosure.

FIG. 5 is a flowchart of the image processing method according to another embodiment of the present disclosure.

FIG. 6 is a schematic structural diagram of the UAV according to an embodiment of the present disclosure.

### DETAILED DESCRIPTION OF THE EMBODIMENTS

In order to make the objectives, technical solutions, and advantages of the present disclosure more clear, the technical solutions in the embodiments of the present disclosure will be described below with reference to the drawings. It will be appreciated that the described embodiments are some rather than all of the embodiments of the present disclosure. Other embodiments conceived by those having ordinary skills in the art on the basis of the described embodiments without inventive efforts should fall within the scope of the present disclosure. In the situation where the technical solutions described in the embodiments are not conflicting, they can be combined.

Embodiments of the present disclosure provide an image process method and a UAV. It should be noted that the image processing method provided in the embodiments of the present disclosure is not only application to UAVs, but also applicable to other movable platforms with imaging devices in two or more directions. For example, an unmanned vehicle. The following description of the present disclosure takes a UAV as an example. In some embodiments, the two or more direction may include two or more directions of the front, rear, bottom, left side, and right side of the UAV. In some embodiments, the imaging device may include one or more of a monocular vision sensor, a binocular vision sensor, and a main shooting camera.

For example, two vision sensors may be disposed at the front end of the UAV, and these two vision sensors can form a binocular vision system. Similarly, two vision sensor may be disposed at the rear end and the bottom of the UAV to form a binocular vision system respectively. A vision sensor may be disposed on the left and right sides of the UAV to form a monocular vision system respectively. A main shooting camera may also be disposed on the UAV to form a monocular vision system.

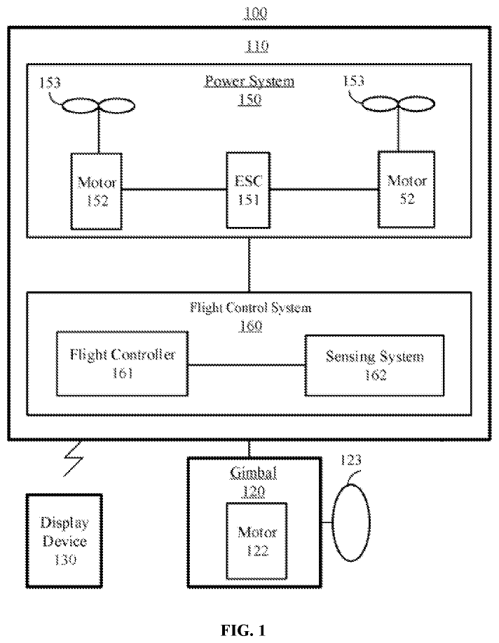

FIG. 1 is a schematic architecture diagram of a UAV according to an embodiment of the present disclosure. This embodiment is described by taking a rotorcraft UAV as an example.

The UAV system 100 may include UAV 110. The UAV 110 includes a power system 150, a flight control system 160, and a frame. In some embodiments, the UAV system 100 may also include a gimbal 120. In some embodiments, the UAV system 100 may further include a display device 130. The UAV 110 can wirelessly communicate with the display device 130.

The frame may include a body and a tripod (also called a descending gear). The body may include a center frame and one or more arms connected to the center frame. One or more arms extend radially from the center frame. The tripod is connected to the body, configured to support the UAV 110 during descending

The power system 150 may include one or more electronic speed governors (referred to as ESGs) 151, one or more propellers 153, and one or more electric motors 152 corresponding to the one or more propellers 153, the electric motors 152 being connected between the electronic speed governor 151 and the propeller 153, the motor 152 and the propeller 153 being disposed on the arm of the UAV 110. The electronic speed governor 151 is configured to receive a driving signal generated by a flight control system 160 and supply driving current to the motor 152 based on the driving signal, to control a rotation speed of the motor 152. The motor 152 is configured to drive the propeller to rotate, so as to supply power for a flight of the UAV 110, and such power enables the UAV 110 to achieve movement in one or more degrees of freedom. In some embodiments, the UAV 110 may rotate about one or more rotation axes. For example, the rotation axes may include: a roll axis, a yaw axis, and a pitch axis. It should be understood that the motor 152 may be a DC motor or an AC motor. In addition, the motor 152 may be a brushless motor or a brushed motor.

The flight control system 160 may include a flight controller 161 and a sensing system 162. The sensing system 162 is configured to measure attitude information of the UAV, for example, location information, attitude information, and speed information of the UAV 100 in space, such as a three-dimensional location, three-dimensional angle, three-dimensional velocity, three-dimensional acceleration, and three-dimensional angular velocity, etc. The sensing system 162 may include, e.g., at least one of: a gyroscope, an ultrasonic sensor, an electronic compass, an inertial measurement unit (IMU), a vision sensor, a global navigation satellite system, or a barometer. For example, the global navigation satellite system may be a Global Positioning System (GPS). The flight controller 161 is configured to control the UAV 110. For example, the flight controller 161 may control the UAV 110 based on the attitude information measured by the sensing system 162. It should be understood that the flight controller 161 may control the UAV 110 based on pre-programmed instructions, and may also control the UAV 110 through a shooting screen.

The gimbal 120 may include a motor 122. The gimbal is configured to carry a photographing device 123. The flight controller 161 may control the movement of the gimbal 120 through the motor 122. Optionally, as another embodiment, the gimbal 120 may further include a controller configured to control the movement of the gimbal 120 by controlling the motor 122. It should be understood that the gimbal 120 may be independent of, or part of, the UAV 110. It should be understood that the motor 122 may be a DC motor or an AC motor. In addition, the motor 122 may be a brushless motor or a brushed motor. It should also be understood that the gimbal can be located on top of the UAV or at a bottom of the UAV.

The imaging device 123 may be, for example, a device for capturing an image, such as a camera or a video camera. The imaging device 123 may communicate with the flight controller and perform photographing under control of the flight controller. The flight controller may also control the UAV 110 based on the image captured by the imaging device 123. The imaging device 123 of this embodiment includes at least a photosensitive component. The photosensitive element is, for example, a complementary metal oxide semiconductor (CMOS) sensor or a charge-coupled device (CCD) sensor. It can be understood that the imaging device 123 can also be directly fixed on the UAV 110, so that the gimbal 120 may be omitted.

The display device 130 can be located on the ground end of the UAV system 100. The display device 130 can communicate with the UAV 110 in a wireless manner, and can be used to display the attitude information of the UAV 110. In addition, the image captured by the imaging device can also be displayed on the display device 130. It can be understood that the display device 130 may be a device independent of the UAV 110.

It should be understood that the above-mentioned naming of each component of the UAV system is for identification purposes only, and should not be construed as limiting the embodiments of the present disclosure.

The coordinate system involved in the embodiments of the present disclosure will be described below.

1) Image Coordinate System.

The image coordinate system is a two-dimensional (2D) plane, also known as the image plane, which can be understood as the surface of the sensor in the imaging device. Each sensor has a certain size and a certain resolution, which determines the conversion relationship between millimeters and pixels. The coordinates of a point in the image coordinate system can be expressed as (u, v) in pixels, or as (x, y) in millimeters. In other words, the image coordinate system can be divided into an image pixel coordinate system and an image physical coordinate system. The unit of the image pixel coordinate system can be pixels, and the two coordinate axes can be referred to as U axis and V axis respectively.

2) Camera Coordinate System.

The camera coordinate system is a 3D coordinate system. The origin of the camera coordinate system can be the optical center of the camera (lens). The X axis (also known as the U axis) and Y axis (also known as the V axis) of the camera coordinate system can be respectively parallel to the X axis (U axis) and Y axis (V axis) of the image coordinate system. The Z axis can be the optical axis of the camera.

3) Ground Coordinate System.

The ground coordinate system is a 3D coordinate system, which can also be referred to as a world coordinate system, a navigation coordinate system, a local horizontal coordinate system, or a North-East-Down (NED) coordinate system, which is generally used in navigation calculations. In the ground coordinate system, the X axis points to the North, the Y axis points to the East, and the Z axis points to the center of the earth (Down). X axis and Y axis are tangent to the surface of the earth.

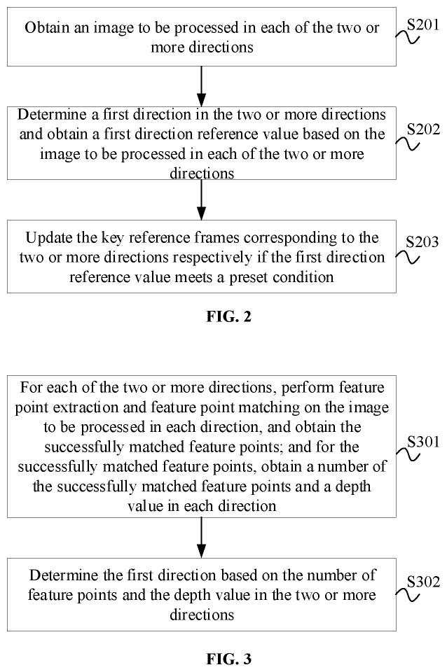

FIG. 2 is a flowchart of an image processing method according to an embodiment of the present disclosure. The execution body of the image processing method provided in this embodiment may be a UAV. An imaging device may be disposed in two or more directions of the imaging device. The number of imaging device disposed in each direction is not limited in the embodiments of the present disclosure. The image processing method will be described in detail below.

S201, obtaining an image to be processed in each of the two or more directions.

In some embodiments, the image to be processed in each direction may include images collected by one or more imaging device in that direction.

S202, determining a first direction in the two or more directions and obtaining a first direction reference value based on the image to be processed in each of the two or more directions.

In some embodiments, the first direction reference value can be used to determine whether to update the key reference frames respectively corresponding to the two or more directions.

More specifically, each imaging device in each direction may correspond to a key reference frame. The key reference frame may be one of the plurality of frames of images collected by the imaging device before the current time. The key reference frame can be used as a comparison reference, and the position information of the image collected by the imaging device after the key reference frame can be obtained through the key reference frame. Therefore, whether the key reference frame is appropriate will directly affect the accuracy of the position information of the image, and further affect the accuracy of the obtained UAV position, attitude information, or speed information. During the flight of the UAV, the attitude of the UAV and the attitude of each imaging device are changing. Therefore, the key reference frame of the imaging device needs to be updated.

Each direction may update the key reference frame separately based on the change of the direction, and the time to update the key reference frame in each direction may be different. Since each direction determines whether to update the key reference frame separately, the amount of calculation is relatively large and the processing efficiency is low.

In the embodiments of the present disclosure, the first direction can be determined first among the two or more directions. Based on the first direction reference value, whether the key reference frame corresponding to each direction needs to be updated at the same time can be determined. Since the determination only needs to be made in one direction, that is, the first direction, the amount of calculation is reduced, the complexity of updating the key reference frame is simplified, and the processing efficiency is improved.

S203, updating the key reference frames corresponding to the two or more directions respectively if the first direction reference value meets a preset condition.

It should be noted that when the first direction reference value is different, the corresponding preset condition can be different. The preset condition is not limited in the embodiments of the present disclosure.

The image process method provided in the embodiments of the present disclosure can be applied to a UAV in which imaging devices can be disposed in multiple directions. By determining the first direction in multiple directions, only one direction is used to determine whether the condition for updating the key reference frame is met. If the condition is met, the corresponding key reference frames in all direction can be switched at the same time. In this way, the amount of calculation can be reduced, the complexity of updating the key reference frame can be simplified, and the processing efficiency can be improved.

FIG. 3 is a flowchart of the image processing method according to another embodiment of the present disclosure. Based on the image processing method shown in FIG. 2, an embodiment of the present disclosure provides another implementation of the image processing method. More specifically, an implementation method of determining the first direction in the two or more directions based on the image to be processed in each of the two or more directions in the process at S202 is provided.

As shown in FIG. 3, determining the first direction in the two or more directions based on the image to be processed in each of the two or more directions (i.e., the process at S202) can include the following processes.

S301, for each of the two or more directions, performing feature point extraction and feature point matching on the image to be processed in each direction, and obtaining the successfully matched feature points; and for the successfully matched feature points, obtaining a number of the successfully matched feature points and a depth value in each direction.

In some embodiments, the depth value of each direction can be determined based on the depth values corresponding to the successfully matched feature points.

S302, determining the first direction based on the number of feature points and the depth value in the two or more directions.

More specifically, the number of successfully matched feature points in each direction can reflect the magnitude of change in that direction. The more the number of feature points, the smaller the change in the direction. Conversely, the smaller the number of feature points, the greater the change in the direction. The depth value in each direction can reflect the distance of the UAV. The greater the depth value, the farther the UAV may be. Conversely, the smaller the depth value, the closer the UAV may be.

By comprehensively considering the number of successfully matched feature points and the depth value, the accuracy in determining the first direction can be improved.

It should be noted that the feature point extraction method and the feature point matching method are not limited in the embodiments of the present disclosure. For example, the feature point matching can use the Kanade-Lucas-Tomasi feature tracker (KLT).

In some embodiments, in the process at S302, determining the first direction based on the number of feature points and the depth value may include obtaining a ratio of the number of feature points to the depth value in each direction, and sorting the ratios, the direction corresponding to the maximum ratio can be determined as the first direction.

More specifically, in each direction, based on the number of the successfully matched feature points and the depth value in that direction, the ratio of the number of the successfully matched feature points and the depth value can be determined. For example, N may be used to represent the number of feature points successfully triangulated, and d0 may represent the depth value of each direction. The number of successfully matched feature points N can be compared to the depth value of each direction d0 to obtain the ratio N/d0. For a ratio, the larger the ratio, the larger the numerator, and/or the smaller the denominator. The more the number of feature points, the smaller the change in the direction. The smaller the depth value, the closer the UAV.

It can be seen that by determining the direction corresponding to the maximum ratio between the number of feature points and the depth value as the first direction can further improve the accuracy and rationality of determining the first direction.

The depth value in each direction will be described below.

In some embodiments, in the process at S301, the depth value of each direction may be determined based on the depth values corresponding to the successfully matched feature points. For example, the depth value of each direction may be an average of the corresponding depth values based on the successfully matched feature points.

For example, if there are ten successfully matched feature points, then the depth value in this direction may be the average of the depth values corresponding to the ten successfully matched feature points.

In some embodiments, in the process at S301, the depth value of each direction may be determined based on the depth values corresponding to the successfully matched feature points. For example, the depth value of each direction may be based on the histogram statistical value of the depth values of the successfully matched feature points.

The histogram is an accurate image representation of the distribution of numerical data, which can be normalized to display the “relative frequency.” The histogram statistics can be used as the depth value in each direction, which takes the frequency distribution into account, thereby further improving the accuracy of depth value in each direction.

The method of obtaining the depth value in each direction based on different scenarios will be described below.

In some embodiments, the imaging device of the UAV may include a binocular vision system equipped with two imaging devices, and the image to be processed in each direction may include the images collected by the two imaging devices respectively.

In the process at S301, performing feature point extraction and feature point matching on the image to be processed in each direction to obtain the successfully matched feature points may include performing feature point extraction and feature point matching on the images respectively collected by the two imaging devices to obtain the number of successfully matched feature points.

In the process at S301, if the number of feature points is greater than or equal to a first preset threshold, then obtaining the depth value in each direction may include using a binocular matching algorithm to obtain the depth value of the successfully matched feature points, and determining the depth value of each direction based on the depth value of the successfully matched feature points.

More specifically, this implementation can be used in the direction of forming the binocular vision system. When the number of successfully matched feature points is greater than or equal to the first preset threshold, the binocular matching algorithm can be used to obtain the depth value in that direction.

In some embodiments, if the number of feature points is less than the first preset threshold, then obtaining the depth value of each direction in the process at S301 may include, for at least one imaging device of the two imaging devices, if a triangulation algorithm is used to obtain the depth value of one or more successfully matched feature points based on the plurality of images collected by the at least one imaging device, determining the depth value of each direction based on the obtained depth value of one or more successfully matched feature points. In some embodiments, a triangulation algorithm can be used to obtain the depth value of one or more successfully matched feature points based on two images collected by the at least one imaging device, and then the depth value in each direction can be determined based on the obtained depth value of the one or more successfully matched feature points.

More specifically, this implementation can be used in the direction of forming the binocular vision system. When the number of successfully matched feature points is less than the first preset threshold, the triangulation algorithm can be used to obtain the depth value of that direction.

The triangulation algorithm will be briefly described below.

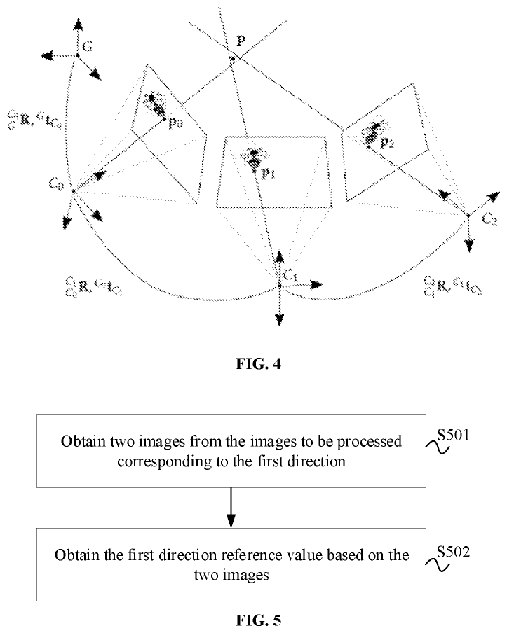

FIG. 4 is a schematic diagram of the principle of a triangulation algorithm involved in an embodiment of the present disclosure. As shown in FIG. 4, G represents the origin in the world coordinate system. C0, C1, and C2 are three different camera attitudes shooting the same bee from different angles. It can be seen that the positions of the points of the bee stings on the images collected at different angles are different, which as p0, p1, and p2. When the camera attitudes of C0, C1, and C2 (where R represents the rotation transformation, and t represents the translation transformation), the true 3D position of the bee sting P can be solved. It can be seen that this is very similar to GPS positioning, which is observed from multiple angles, and the attitude is known to solve the 3D position of a point.

Theoretically, P(x, y, z) is projected onto the normalized plane of the C0 camera position as

$${p}_{0}^{′} = [ \begin{matrix}{u}_{0}^{′} \\ {v}_{0}^{′} \\ 1\end{matrix} ] = π ( {}_{G}^{{c}_{0}} R ( P - {}_{}^{G}{t}{}_{{c}_{0}}^{} ) ) , π ( [ \begin{matrix}x \\ y \\ z\end{matrix} ] ) = [ \begin{matrix}x / z \\ y / z \\ z / z\end{matrix} ] = [ \begin{matrix}x / z \\ y / z \\ 1\end{matrix} ]$$

Then p₀=[u₀, v₀]^{T} can be obtained. Ideally, p₀′=p₀, but in fact, p₀′ will not be perfectly equal to p₀, and the error generated here is the reprojection error. Therefore, in order to minimized the error, image observations of multiple camera positions can be used to optimize the process:

$${arg}_{P ( x , y , z )} min {\sum }_{i = 0}^{n} [ {( {u}_{i} - {u}_{i}^{′} )}^{2} + {( {v}_{i} - {v}_{i}^{′} )}^{2} ]$$

It can be seen that through the triangulation algorithm, by observing from two or more angles, the 3D position of a point can be obtained when the attitude changes are known.

It should be noted that this embodiment does not limit the number of angles that need to be observed in the triangulation algorithm, or in other words, the number of images that need to be collected by the same imaging device is not limited, which can be two or more.

In some embodiments, the imaging device of the UAV may include a monocular vision system equipped with an imaging device, and the image to be processed in each direction may include a plurality of images collected by the imaging device. In some embodiments, the image to be processed in each direction may include two images collected by the monocular vision system.

In the process at S301, performing feature point extraction and feature point matching on the image to be processed in each direction to obtain the successfully matched feature points may include perform feature point extraction and feature point matching on two images to obtain the number of successfully matched feature points.

In the process at S301, obtaining the depth value of each direction may include determining the depth value of each direction based on the obtained depth value of one or more successfully matched feature points if the triangulation algorithm is used to obtain the depth value of the one or more successfully matched feature points.

More specifically, this implementation can be applied to the direction of forming a monocular vision system. When the triangulation algorithm succeeds at least once and the depth value of the one or more successfully matched feature points is obtained, the depth value of the direction can be obtained through the triangulation algorithm.

In some embodiments, in the process at S301, obtaining the depth value of each direction may also include determining a preset depth value as the depth value in each direction if the depth value of any one of the successfully matched feature points cannot be obtained by using the triangulation algorithm.

More specifically, this implementation can be applied to a scene using a triangulation algorithm. For example, in the direction of forming a monocular vision system. In another example, although a direction can form a binocular vision system, only the images collected by one of the imaging devices may use the triangulation algorithm. In addition, when the triangulation algorithm has not succeeded once and the depth value of the feature point that is successfully matched cannot be obtained, the preset depth value can be determined as the depth value in the direction.

It should be noted that the embodiments of the present disclosure do not limit the specific value of the preset depth value, which can be 500 meters.

The first direction will be described below through specific scenarios.

In one example, the UAV may fly out from a window of a tall building. At this time, the height of the UAV may change.

For the original first direction, when the UAV flies out of the window, the first direction may be considered to be the imaging device positioned below the UAV, that is, the downward direction. In the downward direction, the triangulation algorithm has the most successful feature points. However, due to the height change, the depth value of the downward direction is very large, and the downward direction may no longer be suitable as the first direction at this time.

For the redefined first direction, since the depth vale of the points in the downward direction is very larger, even if the number of points successfully triangulated is relatively large, by comprehensively considering the number of successfully triangulated points and the depth value, and compare the N/d0 in each direction, the first direction may be modified to a direction other than the downward direction, such as the rear direction. In some embodiments, N may represent the number of feature points successfully triangulated, and d0 may represent the depth value in each direction.

In another example, the UAV may vibrate during brake when flying in a low-altitude sports gear with large poses.

For the original first direction, the field of vision (FoV) in the downward direction is large, and most feature points can be seen. At this time, the downward direction may still be considered as the first direction.

For the redefined first direction, when the pose of the UAV is large, the UAV may tilt forward, and the forward direction may be closer to the ground at this time. By comparing the N/d0 in each direct, the first direction may be modified to the forward direction at this time.

Consistent with the present disclosure, when determining the first direction, for each of the two or more directions, feature point extraction and feature point matching can be performed on the image to be processed in each direction to obtain the successfully matched feature points. For the successfully matched feature points, the number of successfully matched feature points and the depth value of each direction can be obtained, and the first direction can be determined based on the number of feature points and the depth value in the two or more directions. The image processing method provided in the embodiments of the present disclosure can improve the accuracy of determining the first direction by comprehensively considering the number of successfully matched feature points and the depth values.

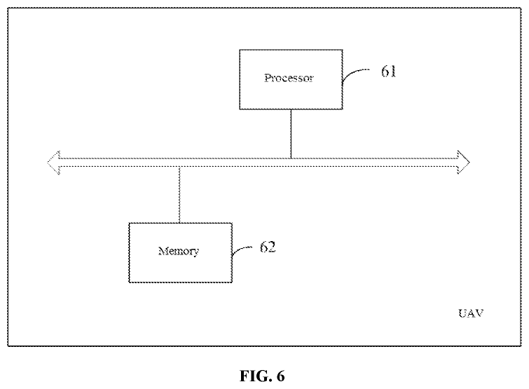

FIG. 5 is a flowchart of the image processing method according to another embodiment of the present disclosure. Based on the image processing method shown in FIG. 2, an embodiment of the present disclosure provides another implementation of the image processing method. More specifically, an implementation method of obtaining the first direction reference value in the process at S202 is provided.

As shown in FIG. 5, obtaining the first direction reference value (the process at S202) includes the following processes.

S501, obtaining two images from the images to be processed corresponding to the first direction.

S502, obtaining the first direction reference value based on the two images.

More specifically, after determining the first direction, two images can be selected from the images to be processed of the first direction to obtain the first direction reference value.

In some embodiments, the two obtained images may include two images collected by the same imaging device in the first direction.

In some embodiments, there may be a time interval between two images collected by the same imaging device. In order to improve the accuracy of the first direction reference value, the time interval may be less than or equal to a preset time interval. The specific value of the time interval is not limited in the embodiments of the present disclosure.

In some embodiments, the tow images collected by the same imaging devices may include two adjacent frames of images collected by the same imaging device.

The method of obtaining the first direction reference value will be described below.

In some embodiments, the first direction reference value may include a success rate of feature point matching between the two images, and the corresponding preset condition may be the success rate of feature point matching being less than or equal to a second preset threshold.

Correspondingly, in the process at S203, if the first direction reference value meets the preset condition, updating the key reference frames corresponding to two or more directions may include updating the key reference frames corresponding to two or more directions respectively if the success rate of feature point matching is less than or equal to the second preset threshold.

More specifically, the higher the success rate of the feature point matching, the smaller the change in the first direction. Conversely, the lower the success rate of the feature point matching, the greater the change in the first direction. If the success rate of the feature point matching is less than or equal to a certain value, and the change is large enough, the current key reference frame may be inaccurate, therefore, the key reference frames corresponding to two or more directions can be updated.

It should be noted that the specific value of the second preset threshold is not limited in the embodiments of the present disclosure, such as 50%.

In some embodiments, the first direction reference value may include the parallax of the feature points that are successfully matched between the two images, and the corresponding preset condition may be the parallax of the feature points that are successfully matched between the two images being greater than or equal to a third preset threshold.

Correspondingly, in the process at S203, updating the key reference frames corresponding to two or more directions if the first direction reference value meets the preset condition may include updating the key reference frames corresponding to two or more directions respectively if the parallax of the successfully matched feature points between the two images are greater than or equal to the third preset threshold.

More specifically, the greater the parallax of the successfully matched feature points, the greater the change in the first direction. Conversely, the smaller the parallax of the successfully matched feature points, the smaller the change in the first direction. If the parallax of the successfully matched feature points is greater than or equal to a certain value, and the change is large enough, the current key reference frame may be inaccurate, therefore, the key reference frames corresponding to two or more directions can be updated.

It should be noted that the specific value of the third preset threshold is not limited in the embodiments of the present disclosure, such as ten pixels.

It should be noted that when the first direction reference value includes the parallax of the successfully matched feature points between the two images, the parallax may be determined based on the parallax of all the successfully matched feature points between the two images.

In some embodiments, the first direction reference value may be the average value of the parallax of all successfully matched feature points between the two images.

In some embodiments, the first direction reference value may be a histogram statistical value of the parallax of all successfully matched feature points between the two images.

In some embodiments, the first direction reference value may include the success rate of the feature point matching between the two images and the parallax of the successfully matched feature points between the two images. More specifically, if the success rate of the feature point matching is greater than the second preset threshold, the parallax of the successfully matched feature points between the two images can be further determined. If the parallax of the successfully matched feature points between the two images is greater than or equal to the third preset threshold, the key reference frames corresponding to two or more directions can be updated respectively.

Consistent with the present disclosure, by obtaining two images from the images to be processed corresponding to the first direction, the first direction reference value can be obtained from the two images. If the first direction reference value meets the key reference frame update condition, the key reference frames corresponding to each direction in all directions can be switched at the same time. In this way, the amount of calculation can be reduced, the complexity of updating the key reference frames can be simplified, and the processing efficiency can be improved.

An embodiment of the present disclosure further provides an image process method. Based on the embodiments shown in FIG. 2 to FIG. 5, this embodiment provides another implementation method of the image process method.

The image processing method provided in this embodiment may include determining a second direction in two or more directions based on the depth value corresponding to each of the two or more directions.

More specifically, the depth value corresponding to each direction can reflect the distance of the UAV in each direction. The greater the depth value, the farther the UAV may be in that direction. Conversely, the smaller the depth value, the closer the UAV may be in that direction. The second direction can be determined in the two or more directions by the depth value corresponding to each of the two or more directions respectively. The second direction can be used to provide the basis for the selecting the data source when obtaining the position, attitude, and speed information of the UAV, thereby improving the accuracy of determining the position, attitude, and speed information of the UAV.

In some embodiments, determining the second direction in the two or more directions based on the depth value corresponding to each of the two or more directions may include determining the direction corresponding to a minimal value of the depth value as the second direction in the two or more directions. By determining the direction with the minimal depth value, that is, the direction closest to the UAV as the second direction, the accuracy of selecting the data source can be improved.

In some embodiments, the image processing method provided in this embodiment may further include obtaining the current frame of image to be processed for each of the two or more directions; obtaining the feature points that are successfully matched with the corresponding key reference frame in the current frame of image based on the current key reference frame corresponding to each direction; and obtaining a first number of feature points in the second direction, and a preset number of feature points in other directions other than the second direction based on the feature points that are successfully matched with the corresponding key reference frame in each direction. In some embodiments, the first number may be greater than the preset number corresponding to other directions.

The following is an example to describe this embodiment.

Assume that the two or more directions include the front (front view), rear (rear view), downward (downward view) left side (left view), right side (right view) of the UAV, and the second direction is the downward view. When selecting the data sources, the downward view may be selected as the main data source. For example, 50 successfully matched feature points can be selected in the downward direction. In each of the other directions, 30 successfully matched feature points can be selected. In this way, a total of 50+4*30=170 feature points can be selected. Moreover, since the second direction is the main data source, the accuracy of selecting the data sources can be improved.

It should be noted that the specific values of the first number and the preset numbers corresponding to each of the other directions are not limited. The preset values corresponding to the other directions may be the same or different.

In some embodiments, the image processing method provided in this embodiment may further include obtaining the 3D position information of the feature points based on the feature points that are successfully matched with the corresponding key reference frame in the current frame of image in two or more directions.

The movement information of the UAV can be obtained based on the 3D position information. In some embodiments, the 3D position information may be the 3D position information in the UAV coordinate system or the 3D position information in the imaging device coordinate system, or the 3D position information in the world coordinate system.

In some embodiments, after obtaining the 3D position information of the feature points, algorithms such as Kalman Filter can be used to obtain the movement information of the UAV.

In some embodiments, the movement information of the UAV may include one or more of the position information of the UAV, the attitude information of the UAV, and the speed information of the UAV.

Consistent with the present disclosure, the second direction can be determined in the two or more directions based on the depth value corresponding to each of the two or more directions. The second direction can be used to subsequently obtain the position, attitude, and speed information of the UAV to provide the main basis for selecting the data source. In this way, the accuracy of determining the positon, attitude, and speed information of the UAV can be improved.

An embodiment of the present disclosure further provides an image processing method. Based on the image processing method provided in the foregoing embodiments, this embodiment provides another implementation method of the image processing method.

In some embodiments, the image process method may further include removing the outliers in the successfully matched feature points.

More specifically, by removing the outliers in the successfully matched feature points, the successfully matched feature points can be more accurate, thereby improving the accuracy of updating the key reference frames, and improving the accuracy of determining the movement information of the UAV.

It should be noted that the execution positon of removing the outliers in the successfully matched feature points is not limited in the embodiments of the present disclosure, and the outliers can be removed from the output successfully matched feature points. For example, in the process at S301, after the successfully matched feature points are obtained, the process of removing the outliers from the successfully matched feature points can be performed.

Correspondingly, obtaining the 3D position information of the feature points based on the feature points that successfully match the corresponding key reference frame in the current frame of image in two or more direction, and obtaining the movement information of the UAV based on the 3D position information may include obtaining the 3D position information of the feature points based on the feature points that have performed the outlier removal process in two or more direction, and obtaining the movement information of the UAV based on the 3D position information.

In some embodiments, removing the outliers in the successfully matched feature points may include using the Epipolar constraint algorithm to remove the outliers in the successfully matched feature points.

In some embodiments, removing the outliers in the successfully matched feature points may include, for each of the two or more directions, obtaining the 3D position information of the feature points in the key reference frame currently corresponding to each direction, obtaining the 2D position information of the feature points that are successfully matched with the corresponding key reference frame in the current frame of image to be processed in each direction, and obtaining a first external parameter of the key reference frame and the current frame of image; obtaining a second external parameter of the key reference frame and the current frame of image based on the 3D position information, the 2D position information, and the first external parameter; obtaining a plurality of second external parameters, and performing mutual verification on the plurality of obtained second external parameters, the feature points failing the verification being the outliers in the successfully matched feature points; and removing the outliers in the successfully matched feature points.

In some embodiments, the first external parameter may include a rotation matrix and/or a translation matrix, and may refer to data measured by sensors such as an inertial measurement unit (IMU). The second external parameter may include a rotation matrix and/or a translation matrix, and may be the data obtained based on the 3D position information of the feature points in the key reference frame currently corresponding to each direction, the 2D position information of the feature points that are successfully matched with the corresponding key reference frame in the current frame of image to be processed in each direction, and the first external parameter. In some embodiments, the perspective-n-point (PNP) algorithm can be used to obtain the second external parameter. Subsequently, the second external parameters corresponding to a plurality of feature points in the current frame of image can be obtained, and the feature points that fail the verification, that is, the outliers, can be removed by mutual verification of the second external parameters corresponding to the plurality of feature points. By removing the outliers through the combination of the PNP algorithm and the verification algorithm, the accuracy of removing the outliers can be further improved.

It should be noted that the verification algorithm is not limited in the embodiments of the present disclosure, for example. It can be a random sample consensus (RANSAC) algorithm.

In some embodiments, obtaining the 3D position information of the feature points in the key reference frame corresponding to each direction may include obtaining the 3D position information of the feature points in the key reference frame corresponding to each direction by using the binocular matching algorithm or the triangulation algorithm.

In some embodiments, if the successfully matched feature points are obtained from the images respectively collected by two imaging devices in the binocular vision system, removing the outliers in the successfully matched feature points may include obtaining the parallax of each successfully matched feature point; if the proportion of feature points with the parallax greater than or equal to a fourth preset threshold in the successfully matched feature points is greater than or equal to a fifth preset threshold, for each feature point whose parallax is greater than or equal to the fourth preset threshold, comparing the difference between the depth values of each feature point obtained by the binocular matching algorithm and the triangulation algorithm; and removing each feature point if the difference is greater than or equal to a sixth preset threshold.

More specifically, the parallax of each successfully matched feature point needs to be obtained first, then probability statistics can be performed on all parallaxes. Assume that 80% of the feature points have parallaxes less than 1.5 pixels. At this time, the fourth preset threshold may be 1.5 pixels, and the fifth preset threshold may be 20%. Then it may be needed to further verify why the parallax of the remaining 20% of the feature points is relatively large. At this time, for each of the remaining 20% of each feature point, the depth value of each feature point obtained by the binocular matching algorithm and the triangulation algorithm can be respectively used, and the difference between the depth values can be compared. If the difference is greater than or equal to the sixth preset threshold, the feature point can be removed.

By distinguishing a part of the feature points through probability statistics, and then filtering outliers in this part of the feature points through the binocular matching algorithm and the triangulation algorithm, the outliers can be removed. In this way, the accuracy of removing the outliers can be improved.

In some embodiments, removing the outliers in the successfully matched feature points may include, for each feature point that is successfully matched with the corresponding key reference frame in the in the current frame of image to be processed in each of the two or more directions, obtaining the reprojection 2D position information of each feature point in the current frame of image based on the 3D position information of each information; obtaining the reprojection error of each feature point based on the 2D position information of each feature point in the current frame of image and the reprojection 2D position information; and removing each feature point if the reprojection error is greater than or equal to a seventh preset threshold.

More specifically, for each feature point in the current frame of image to be processed in each direction that successfully matches the corresponding key reference frame, the reprojected 2D position information after the reprojection can be obtained based on the 3D position information of the feature points through the conversion relationship between the 3D position information and the 2D position information. Subsequently, the 2D position information of the feature point in the current frame of image can be obtained based on the current frame of image. The two 2D position information can be reprojected and compared. If the reprojection error is greater than or equal to the seventh preset threshold, then each feature point can be removed.

In one example, assume that there is a feature point A in the current frame of image in the front view direction of the UAV. The feature point A may be successfully matched with the key reference frame in the forward direction. Through calculation, the 3D position information of the feature point A can be obtained. Now, based on the 3D position information of the feature point A, the feature point A may be reprojected in the current frame of image to obtain the reprojected 2D positon information. Assume the corresponding point is A′. Theoretically, A and A′ should coincide, or the reprojection error between the two should be less than a small value. However, if the reprojection error between the two is large and is greater than or equal to the seventh preset threshold, it may indicate that the feature point A is an outlier that needs to be removed.

It should be noted that the conversion relation between the 3D position information and the 2D position information is not limited in the embodiments of the present disclosure, for example, it may be obtained through the camera model equation.

The camera model equation will be briefly described below.

$${z}_{c} [ \begin{matrix}u \\ v \\ 1\end{matrix} ] = K [ R \vert t ] [ \begin{matrix}{x}_{w} \\ {y}_{w} \\ {z}_{w} \\ 1\end{matrix} ]$$

where [u, v, 1]^{T} represents a 2D point in the homogeneous image coordinates, [x_{w}, y_{w}, z_{w}]^{T} represents a 3D point in the world coordinates, and matrix K is the camera calibration matrix, that is, the intrinsic parameters of the camera.

For a finite projective camera, the matrix K may include five intrinsic parameters, such as

$$K = [ \begin{matrix}{α}_{x} & γ & {μ}_{0} \\ 0 & {α}_{y} & {v}_{0} \\ 0 & 0 & 1\end{matrix} ]$$

where αₓ=fmₓ, α_{y}=fm_{y}, f is the focal length, mx and my are the number of pixels per unit distance in the x and y directions (the scale factors), γ is the skew parameter between the x and y axes (for CCD cameras, the pixels are not squares), and μ₀ and v₀ are the principal points.

The matrix R can be referred to as the rotation matrix, matrix T can be referred to as the translation matrix. R and T may be the extrinsic matrix of the camera, which can be used to express the rotation and translation transformation for the world coordinate system to the camera coordinate system in the 3D space. It can be seen that through the camera model, the 2D position information can be obtained based on the 3D position information.

The effective of removing the outliers will be described below through a specific scenario.

In some embodiments, the UAV may be hovering and the scene below the UAV may be a texture scene. For example, the object below the UAV may be a pure white table.

For the original first direction, when the UAV is hovering, due to the weak texture of the pure white table, the number of feature point matching errors may be large. Since the incorrectly matched feature points cannot be effectively removed, the first direction may still be considered as the downward direction.

For the redefined first direction, after removing the incorrectly matched feature points, the direction with the largest amount of successfully triangulated points may no longer be the downward direction. In this case, the first direction may be modified to be the front view direction or the rear view direction based on the method described above.

Consistent with the present disclosure, by removing the outliers in the successfully matched feature points, the feature points that have been successfully matched can be mode more accurate, thereby improving the accuracy of updating the key reference frames, and improving the accuracy of determining the UAV movement information.

FIG. 6 is a schematic structural diagram of the UAV according to an embodiment of the present disclosure. The UAV provided in this embodiment can be used to execute the image processing method provided in the foregoing embodiments. Further, the UAV provided in this embodiment may include imaging devices in two or more directions. As shown in FIG. 6, the UAV includes a processor 61 and a memory 62.

The memory 62 can be configured to store program instructions. The processor 61 can be configured to execute the program instructions stored in the memory 62. When executed by the processor 61, the program instructions can cause the processor 61 to obtain an image to be processed in each of the two or more directions; determine a first direction in the two or more directions, and obtain a first direction reference value based on the image to be processed in each of the two or more directions, the first direction reference value being used to determine whether to update the key reference frames respectively corresponding to the two or more directions; and update the key reference frames corresponding to the two or more directions respectively if the first direction reference value meets a preset condition.

In some embodiments, when executed by the processor 61, the program instructions can cause the processor 61 to, for each of the two or more directions, perform feature point extraction and feature point matching on the image to be processed in each direction, and obtain the successfully matched feature points; for the successfully matched feature points, obtain a number of the successfully matched feature points and a depth value in each direction; and determine the first direction based on the number of feature points and the depth value in the two or more directions. In some embodiments, the depth value of each direction can be determined based on the depth values corresponding to the successfully matched feature points.

In some embodiments, when executed by the processor 61, the program instructions can cause the processor 61 to obtain a ratio of the number of feature points to the depth value in each direction, and sorting the ratios, the direction corresponding to the maximum ratio can be determined as the first direction.

In some embodiments, determining the depth value in each direction based on the depth values corresponding to the successfully matched feature points may include using the average of the corresponding depth values based on the successfully matched feature points as the depth value of each direction, or using the histogram statistical value of the depth values of the successfully matched feature points as the depth value of each direction.

In some embodiments, the imaging device may include a binocular vision system equipped with two imaging devices, and the image to be processed in each direction may include the images collected by the two imaging devices.

In some embodiments, when executed by the processor 61, the program instructions can cause the processor 61 to perform feature point extraction and feature point matching on the images respectively collected by the two imaging devices to obtain the number of successfully matched feature points; and if the number of feature points is greater than or equal to the first preset threshold, use the binocular matching algorithm to obtain the depth value of the successfully matched feature points, and determine the depth value in each direction based on the obtained depth value of the successfully matched feature points.

In some embodiments, when executed by the processor 61, the program instructions can cause the processor 61 to, if the number of feature points is less than the first preset threshold, for at least one imaging device of the two imaging devices, if a triangulation algorithm is used to obtain the depth value of one or more successfully matched feature points based on the plurality of images collected by the at least one imaging device, determine the depth value of each direction based on the obtained depth value of one or more successfully matched feature points.

In some embodiments, the imaging device may include a monocular vision system equipped with one imaging device, and the image to be processed in each direction may include a plurality of images collected by the imaging device.

In some embodiments, when executed by the processor 61, the program instructions can cause the processor 61 to perform feature point extraction and feature point matching on a plurality of images to obtain the number of feature points that are successfully matched; and determine the depth value of each direction based on the obtained depth value of one or more successfully matched feature point if the triangulation algorithm is used to obtain the depth value of one or more successfully matched feature point.

In some embodiments, when executed by the processor 61, the program instructions can cause the processor 61 to determine a preset depth value as the depth value in each direction if the depth value of any one of the successfully matched feature points cannot be obtained by using the triangulation algorithm.

In some embodiments, when executed by the processor 61, the program instructions can cause the processor 61 to obtain two images from the images to be processed corresponding to the first direction; and obtain the first direction reference value based on the two images.

In some embodiments, the first direction reference value may include a success rate of feature point matching between the two images, and the preset condition may be the success rate of feature point matching being less than or equal to a second preset threshold.

In some embodiments, when executed by the processor 61, the program instructions can cause the processor 61 to update the key reference frames corresponding to two or more directions respectively if the success rate of feature point matching is less than or equal to the second preset threshold.

In some embodiments, the first direction reference value may also include the parallax of the feature points that are successfully matched between two images, and the preset condition may be that the parallax of the feature points that are successfully matched between two images being greater than or equal to the third preset threshold.

In some embodiments, when executed by the processor 61, the program instructions can cause the processor 61 to update the key reference frames corresponding to two or more directions respectively if the parallax of the successfully matched feature points between the two images are greater than or equal to the third preset threshold.

In some embodiments, the first direction reference value may be the average of the parallaxes of all successfully matched feature points between the two images.

In some embodiments, the two images may include two images collected by the same imaging device in the first direction.

In some embodiments, the two images collected by the same imaging device may include two adjacent frames of images collected by the same imaging device.

In some embodiments, when executed by the processor 61, the program instructions can cause the processor 61 to determine the second direction in the two or more directions based on the depth value corresponding to each of the two or more directions.

In some embodiments, when executed by the processor 61, the program instructions can cause the processor 61 to determine the direction corresponding to the minimal value of the depth value as the second direction in the two or more directions.

In some embodiments, when executed by the processor 61, the program instructions can cause the processor 61 to obtain the current frame of image to be processed for each of the two or more directions; obtain the feature points that are successfully matched with the corresponding key reference frame in the current frame of image based on the current key reference frame corresponding to each direction; and obtain a first number of feature points in the second direction, and a preset number of feature points in other directions other than the second direction based on the feature points that are successfully matched with the corresponding key reference frame in each direction. In some embodiments, the first number may be greater than the preset number corresponding to other directions.

In some embodiments, when executed by the processor 61, the program instructions can cause the processor 61 to obtain the 3D position information of the feature points based on the feature points that are successfully matched with the corresponding key reference frame in the current frame of image in two or more directions; and obtain the movement information of the UAV based on the 3D position information.

In some embodiments, the 3D position information may be the 3D position information in the UAV coordinate system, the 3D position information in the imaging device coordinate system, or the 3D position information in the world coordinate system.

In some embodiments, the movement information of the UAV may include one or more of the position information of the UAV, the attitude information of the UAV, and the speed information of the UAV.

In some embodiments, when executed by the processor 61, the program instructions can cause the processor 61 to remove the outliers in the successfully matched feature points.

In some embodiments, when executed by the processor 61, the program instructions can cause the processor 61 to use the Epipolar constraint algorithm to remove the outliers in the successfully matched feature points.

In some embodiments, when executed by the processor 61, the program instructions can cause the processor 61 to, for each of the two or more directions, obtain the 3D position information of the feature points in the key reference frame currently corresponding to each direction, obtain the 2D position information of the feature points that are successfully matched with the corresponding key reference frame in the current frame of image to be processed in each direction, and obtain a first external parameter of the key reference frame and the current frame of image; obtain a second external parameter of the key reference frame and the current frame of image based on the 3D position information, the 2D position information, and the first external parameter; obtain a plurality of second external parameters, and perform mutual verification on the plurality of obtained second external parameters, the feature points failing the verification being the outliers in the successfully matched feature points; and remove the outliers in the successfully matched feature points.

In some embodiments, when executed by the processor 61, the program instructions can cause the processor 61 to obtain the 3D position information of the feature points in the key reference frame corresponding to each direction by using the binocular matching algorithm or the triangulation algorithm.

In some embodiments, if the successfully matched feature points are obtained from the images respectively collected by two imaging devices in the binocular vision system, the processor 61 may be configured to obtain the parallax of each successfully matched feature point; if the proportion of feature points with the parallax greater than or equal to a fourth preset threshold in the successfully matched feature points is greater than or equal to a fifth preset threshold, for each feature point whose parallax is greater than or equal to the fourth preset threshold, compare the difference between the depth values of each feature point obtained by the binocular matching algorithm and the triangulation algorithm; and remove each feature point if the difference is greater than or equal to a sixth preset threshold.

In some embodiments, when executed by the processor 61, the program instructions can cause the processor 61 to, for each feature point that is successfully matched with the corresponding key reference frame in the in the current frame of image to be processed in each of the two or more directions, obtain the reprojection 2D position information of each feature point in the current frame of image based on the 3D position information of each information; obtain the reprojection error of each feature point based on the 2D position information of each feature point in the current frame of image and the reprojection 2D position information; and remove each feature point if the reprojection error is greater than or equal to a seventh preset threshold.

In some embodiments, the two or more directions may include two of the front, rear, bottom, left, and right of the UAV.

In some embodiments, the imaging device may include one or more of a monocular vision sensor, a binocular vision sensor, and a main shooting camera.

The UAV provided in this embodiment can be used to execute the image processing method provided in the foregoing embodiments. The technical principles and technical effects are similar, which will not be repeated here.

A person of ordinary skill in the art may understand that all or part of the steps of implementing the foregoing method embodiments may be implemented by a program instructing related hardware. The program may be stored in a computer-readable storage medium. When the program is executed, the steps including the foregoing method embodiments may be executed. The foregoing storage medium may include various media that can store program codes, such as a ROM, a RAM, a magnetic disk, or an optical disc.

It should be noted that the foregoing embodiments are merely intended for describing the technical solutions of the present disclosure instead of limiting the present disclosure. Although the present disclosure is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present disclosure.

What is claimed is:

1. An image processing method applied in an unmanned aerial vehicle (UAV), the UAV including an imaging device in two or more directions, the method comprising:
obtaining an image to be processed in each of the two or more directions;
determining a first direction in the two or more directions and obtaining a first direction reference value based on the image to be processed in each of the two or more directions, the first direction reference value being used to determine whether to update key reference frames corresponding to the two or more directions respectively; and
updating the key reference frames corresponding to the two or more directions respectively if the first direction reference value meets a preset condition.

2. The method of claim 1, wherein determining the first direction in the two or more directions based on the image to be processed in each of the two or more directions includes:
for each of the two or more directions, performing feature point extraction and feature point matching on the image to be processed in each direction, and obtaining matched feature points;
for the matched feature points, obtaining a number of the matched feature points and a depth value of each direction, the depth value of each direction being determined based on the depth values respectively corresponding to the matched feature points; and
determining the first direction in the two or more directions based on the number of feature point and the depth value.

3. The method of claim 2, wherein determining the first direction based on the number of feature point and the depth value includes:
obtaining a ratio of the number of feature points to the depth value of each direction, sorting the ratios, and determining a direction corresponding to a maximum ratio as the first direction.

4. The method of claim 2, wherein determining the depth value of each direction based on the depth values corresponding to the matched feature points includes:
using an average value of the depth values corresponding to the matched feature points as the depth value of each direction; or
using a histogram statistical value based on the depth value of the matched feature points as the depth value.

5. The method of claim 2, wherein:
the imaging device includes a binocular vision system including two imaging devices, and the image to be processed in each direction including a plurality of images respectively collected by the two imaging devices; and
performing feature point extraction and feature point matching on the image to be processed in each direction to obtain the matched feature points includes:
perform feature point extraction and feature point matching on the plurality of images respectively collected by the two imaging devices to obtain the number of matched feature points; and
obtaining the depth value of each direction if the number of feature point is greater than or equal to a first preset threshold including using a binocular matching algorithm to obtain the depth value of the matched feature points, and determining the depth value of each direction based on the obtained depth value of the matched feature points.

6. The method of claim 5, wherein obtaining the depth value of each direction if the number of feature point is greater than or equal to the first preset threshold includes:
for one or more imaging devices in the two imaging devices, if a triangulation algorithm is used to obtain the depth value of one or more matched feature points based on a plurality of images collected by the one or more imaging devices, determining the depth value of each direction based on the obtained depth value of the one or more matched feature points.

7. The method of claim 2, wherein:
the imaging device includes a monocular vision system including an imaging device, and the image to be processed in each direction including a plurality of images collected by the imaging device; and
performing feature point extraction and feature point matching on the image to be processed in each direction to obtain the matched feature points includes:
performing feature point extraction and feature point matching on the plurality of images to obtain the number of matched feature points; and
obtaining the depth value of each direction includes:
determining the depth value of each direction based on the obtained depth value of one or more matched feature points if a triangulation algorithm is used to obtain the depth value of the one or more matched feature points.

8. The method of claim 6, wherein obtaining the depth value of each direction includes:
determining a preset depth value as the depth value of each direction if the depth value of any one of the matched feature points cannot be obtained by using the triangulation algorithm.

9. The method of claim 1, wherein obtaining the first direction reference value includes:
obtaining two images from the images to be processed corresponding to the first direction; and
obtaining the first direction reference value based on the two images.

10. The method of claim 9, wherein:
the first direction reference value includes a success rate of the feature point matching between the two images; and
updating the key reference frames corresponding to the two or more directions if the first direction reference value meets the preset condition includes:
updating the key reference frames corresponding to the two or more directions respectively if the success rate of the feature point matching is less than or equal to a second preset threshold.

11. The method of claim 9, wherein:
the first direction reference value includes a parallax of the matched feature points between the two images; and
updating the key reference frames corresponding to the two or more directions if the first direction reference value meets the preset condition includes:
updating the key reference frames corresponding to the two or more directions respectively if the parallax of the matched feature points between the two images is greater than or equal to a third preset threshold.

12. The method of claim 11, wherein:
the first direction reference value is an average of the parallaxes of all matched feature points between the two images.

13. The method of claim 9, wherein:
the two images include two images collected by a same imaging device in the first direction.

14. The method of claim 13, wherein:
the two images collected by the same imaging device include two adjacent frames of images collected by the same imaging device.

15. The method of claim 2, further comprising:
determining a second direction in the two or more directions based on the depth value respectively corresponding to each of the two or more directions.

16. The method of claim 15, wherein determining the second direction in the two or more directions based on the depth value respectively corresponding to each of the two or more directions includes:
determining a direction corresponding to a minimal depth value as the second direction in the two or more directions.

17. The method of claim 15, further comprising:
for each of the two or more directions, obtaining a current frame of image to be processed;
obtaining the feature points in the current frame of image that are matched with the corresponding key reference frame based on the key reference frame currently corresponding to each direction; and
obtaining a first number of feature points in the second direction, and a preset number of feature points in directions other than the second direction based on the feature points that are matched with the corresponding key reference frame in each direction, the first number being larger than the preset number respectively corresponding to the other directions.

18. The method of claim 2, further comprising:
removing outliers in the matched feature points.

19. The method of claim 1, wherein:
the two or more directions include two or more of front, rear, bottom, left, and right of the UAV.

20. A UAV comprising:
a processor; and
a storage device storing program instructions that, when being executed by the processor, cause the processor to:
obtain an image to be processed in each direction of two or more directions;
determine a first direction in the two or more directions and obtain a first direction reference value based on the image to be processed in each of the two or more directions, the first direction reference value being used to determine whether to update key reference frames corresponding to the two or more directions respectively; and
update the key reference frames corresponding to the two or more directions respectively if the first direction reference value meets a preset condition.
